(19) United States
(12) Patent Application Publication
(10) Pub. No.: US 2005/0237579 A1
(43) Pub. Date: Oct. 27, 2005

(54) Image editing apparatus, frame searching method and frame searching apparatus for photo movie

(75) Inventors: Koichi Gohara, Kanagawa (JP); Hiroshi Murakami, Kanagawa (JP); Kei Yamaji, Kanagawa (JP); Hajime Araya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/106,696

(22) Filed: Apr. 15, 2005

(30) Foreign Application Priority Data
Apr. 15, 2004 (JP) 2004-120443

(51) Int. Cl. G06F 15/00

(52) U.S. Cl. 358/452

(57) ABSTRACT

A photo movie is produced by giving special effects, such as electronic zooming and panning, to plural still images used as material. The photo movie is produced on the basis of a scenario file in which editing conditions are described in time order. When creating the scenario file, candidate flags are recorded in the scenario file in association with specific frames for which a print order is expected to be placed. When the print order is placed, the corresponding specific frames are searched in the photo movie according to the candidate flags. Searching time is reduced compared to the case where the photo movie is played back from the beginning.

### BACKGROUND OF THE INVENTION

1. Field of the Invention

The present invention relates to an image editing apparatus for producing a photo movie by editing plural still images, and a frame searching apparatus and a method for searching frames in the photo movie.

2. Background Arts

There is a method for viewing plural still images which are captured by a digital camera, by loading the image data in a personal computer (PC) and displaying the images on a monitor through image viewing software. Much of the image viewing software provides a slide show function which switches to display the plural still images at predetermined intervals. Users can easily view a large number of still images using such function.

As a new and a similar method to the slide show function for viewing the still images, PhotoMovie (trademark) is introduced. The photo movie uses the still images as material and edits them (such as image modification and connection), and the still images are thereby played back as if they were moving (see Japanese Patent Laid-Open Publication No. 10-200843, and “LiFE* with Photo Cinema” from Digitalstage,Ltd.,URL:http://www.digitalstage.net/j p/product/life/index.html, searched Apr. 6, 2004). In the photo movie, special effects can be added to the still images, such as zoom-in process, which crops a part of the still image and zooms in on the cropped part, and pan process which moves visual range from end to end across the still image.

The photo movie is to provide a new and unconventional method for viewing the still images. It attracts attention to be a method for reusing a stockpile of the captured still images.

Japanese Patent Laid-Open Publication No. 10-200843 and “LiFE* with Photo Cinema” disclose image editing software for producing the photo movies by using the still images as material. The image editing software is intended to be installed in the personal computer, and available for any PC users.

In the photo movie, various special effects are added to the still images which are used as material, and the users may wish to print a specific frame in the photo movie. In that case, the desired frame is searched while reproducing and forwarding the photo movie, and then cropped for printing.

However, in the above method, it takes time to search the desired frames, since the photo movie has to be reproduced from the beginning.

### SUMMARY OF THE INVENTION

An object of the present invention is to provide an image editing apparatus for editing still images so as to search a specific frame in a photo movie for a short time.

Another object of the present invention is to provide a frame searching method and a frame searching apparatus which enable to search a specific frame in the photo movie for a short time.

In order to achieve the above and other objects, the image editing apparatus according to the present invention includes: a reader for reading plural still images, a scenario file creating section for creating a scenario file which contains editing conditions of the photo movie produced by modifying the plural still images, a photo movie producing section for producing the photo movie using the plural still images on the basis of the scenario file, a candidate flag writer for recording candidate flags, which indicate that the frames are the candidates for a specific purpose, in the scenario file in association with specific frames in the photo movie. The specific frames are, for instance, representative frames for which a print order is expected to be placed. The image editing apparatus further includes a writer for writing the plural still images, the scenario file and the photo movie in the recording medium. The image editing apparatus further includes a frame searching section for searching the specific frames in the photo movie, a display for displaying the searched specific frames and a print order input section for selecting and inputting frames for print order among the displayed specific frames in the display. Print data of the frames, for which the print order is placed, is generated using the still image data.

A frame searching apparatus of the present invention includes a reader for reading photo movie and a scenario file from a recording media and a frame searching section for searching specific frames in the photo movie according to the candidate flags. The frame searching apparatus further includes a display for displaying the searched specific frames and a print order input section for selecting and inputting frames for print order among the specific frames displayed in the display, and a print data generating section for generating print data of the frames, for which the print order is placed, using the still image data.

A frame searching method according to the present invention creates a scenario file for recording editing conditions of a photo movie produced by editing the plural still images. The candidate flags are recorded in the scenario file in association with the specific frames in the photo movie to indicate that the specific frames are candidate frames to be used for a specific purpose. The scenario file and the photo movie are recorded in the recording media. Then, the specific frames are searched in the photo movie.

According to the present invention, the candidate flag is previously recorded in the scenario file in association with the specific frame in the photo movie, and the specific frame is located by searching the candidate flag, the frame can therefore be searched in shorter time than in the case of reproducing the photo movie from the beginning.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a block diagram showing an image editing apparatus;

FIG. 2 is an explanatory view showing a format for storing a photo movie in a recording medium;

FIG. 3 is an explanatory view showing examples of special effects applied to the photo movie;

FIG. 4 is an explanatory view showing examples of the special effects other than those shown in FIG. 3;

FIG. 5 is an explanatory view showing a scenario file;

FIG. 6 is an explanatory view showing a print order screen; and

FIG. 7 is a flowchart showing steps for placing and executing the print order.

### DETAILED DESCRIPTION OF THE EMBODIMENTS

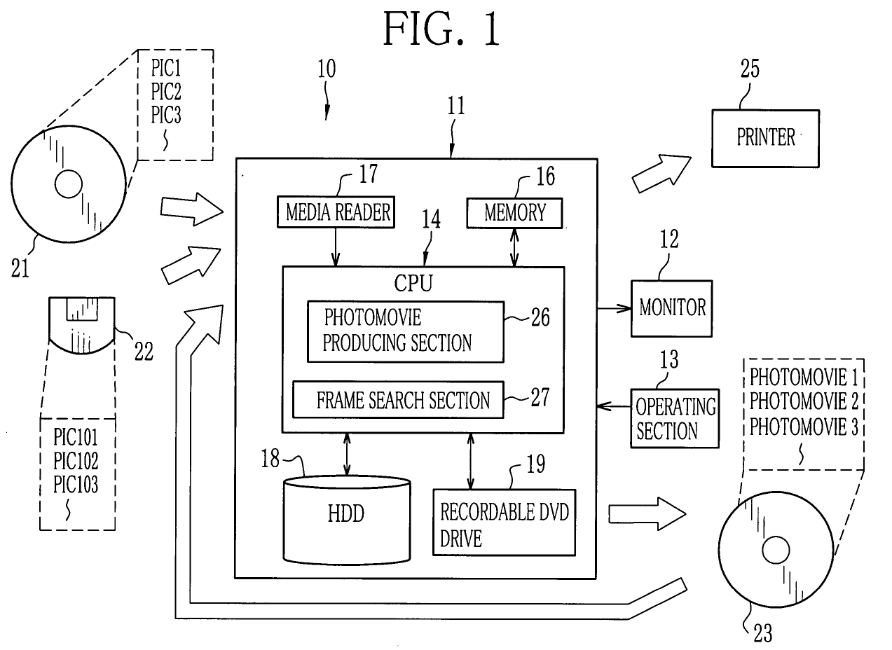

In FIG. 1, an image editing apparatus 10 loads still image data (PIC) stored in a recording medium (for instance, various optical recording media 21 such as a CD and a DVD, and a memory card 22), produces a photo movie based on the loaded still image data and writes out the photo movie in a DVD medium 23. The image editing apparatus 10 is installed in DPE shops and drug stores which offer photo printing service and digital data writing service with the recording media. The image editing apparatus 10 is operated by, for instance, a shop clerk or a user who brings the still image data.

To print the specific frames in the produced photo movie, the user brings the DVD medium 23 to a DPE shop or a drug store, and places a print order as specifying the desired frames. The image editing apparatus 10 has a frame searching function to search the specific frames suitable for printing without reproducing the photo movie. This function can reduce search time. The print order data is transferred to a printer 25 and printing is performed. The printed images are handed over to the user.

The image editing apparatus 10 is constituted of a main body 11, a monitor 12, and an operating section 13. The main body 11 is, for instance, a general purpose personal computer or a work station with a pre-installed image editing program. The main body 11 is constituted of a CPU 14, a memory 16, a media reader 17, a hard disk drive (HDD) 18 and a recordable DVD drive 19. The CPU 14 controls overall operation of each section of the image editing apparatus 10 according to an operating system.

The media reader 17 reads the data from the optical recording media 21 and the memory card 22. The monitor 12 displays an operating screen of the image editing program and the read still images. The operating section 13 includes a mouse and a keyboard and inputs operating instructions to the image editing apparatus 10. The recordable DVD drive 19 is a disk drive which writes data to the DVD medium 23. When accepting the print order, the media reader 17 reads the photo movie and the still image data from the DVD medium 23.

For the DVD medium 23, a recordable DVD−R or DVD+R, a rewritable DVD−RW, DVD+RW or DVD-RAM can be used. Further, there are some data recording formats such as a DVD-VIDEO format, a DVD-VR (Video Recording) format and the like, to specify the file format and the data storage format for the above media. Any one of the above formats can be used. However, for the sake of orderer convenience, it is preferable to select a medium and a format which show the least dependence on the reproducing apparatus.

For that reason, the DVD−R media and the DVD-VIDEO format, which is the data recording format, are used in the image editing apparatus 10. The data recorded with this combination can be reproduced with almost any DVD drives and DVD players incorporated in personal computers.

Other than DVDs, a conventional recording medium such as a CD or a next generation recording medium, which is expected to be widely used such as Blu-ray (registered trademark) can also be used as the recording medium. Furthermore, it is also possible to make the image editing apparatus to handle several types of recording media so as to address customer needs.

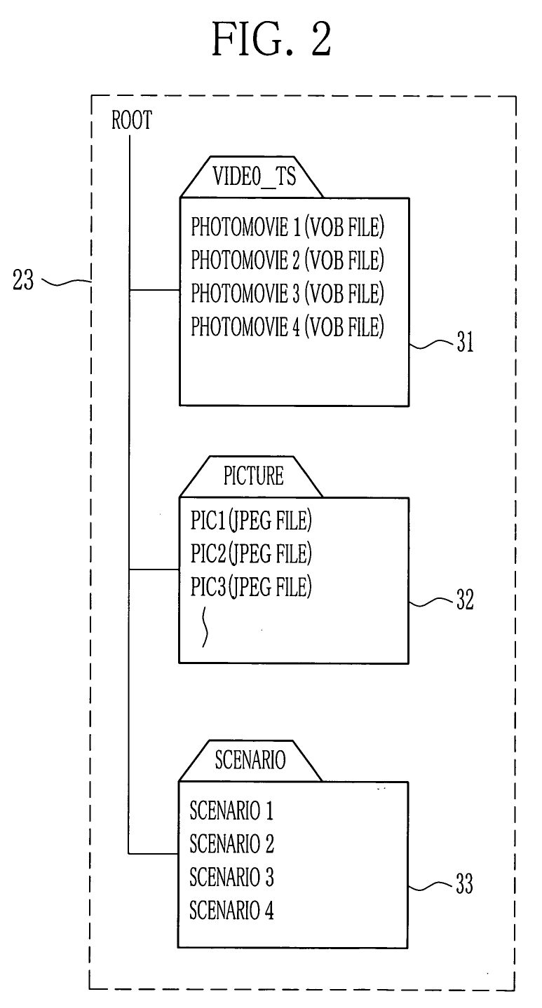

Referring to FIG. 2, when the DVD-VIDEO format is used, the produced photo movie is stored in a VIDEO_TS folder 31 in VOB file format. The VOB file is created by modifying a moving image file, which is encoded in MPEG2 format, in accordance with the DVD-VIDEO format.

The DVD medium 23 has a picture folder 32 and a scenario folder 33. The still image data (PIC), which is used as the material for producing the photo movie, is stored in the picture folder 32. A scenario file 36 is stored in the scenario folder 33. The still image data is a JPEG-file, for instance, which compresses and stores data. It is also possible to store the data in an uncompress file format. Generally, the still image data has three million pixels.

The conditions for editing (which includes modification and connection of the images) to the photo movie are recorded in the scenario file 36 in time order, as described later. The photo movie is produced on the basis of the editing conditions in the scenario file 36. However, the created photo movie file is a complete movie file on its own and independent of the scenario file 36. The scenario file 36 is not used for reproducing the photo movie. The scenario file 36 stored in the DVD medium 23 is used when the user prints the specific frames in the photo movie after viewing. Number of pixels in one frame of the moving image is not sufficient for printing. For instance, an L size print image is 2,024×1,536 pixels while the image in one frame of the photo movie is 640×480 pixels. So, if the scenario file 36 is recorded along with the still image data which is the material of the photo movie, it becomes possible to regenerate any one of the frames from the still image data so as high quality print data to be obtained.

The operating system and the image editing program are stored in the HDD 18. The CPU 14 loads the image editing program to the memory 16, and executes processing steps described in the program. The image editing program includes the processes for producing the photo movie on the basis of the still image data, and for searching the specific frames in the produced photo movie. The CPU 14 functions as a photo movie producing section 26 and a frame searching section 27 in accordance with each of the above processes.

The photo movie producing section 26 creates the scenario file 36 on the basis of the input editing conditions, and produces the photo movie by giving some special effects and image composition to the still images.

The HDD 18 stores decorative images, which is to be combined with the still images, as additional data to the image editing program. The decorative images include mask images and template images. The mask images cover unnecessary parts of the images to be decorated. The template images specify fitting frames of the images to be decorated, and decorate the images with illustrations. Thus, the still images, which are used as the materials for the photo movie, are decorated with the decorative images.

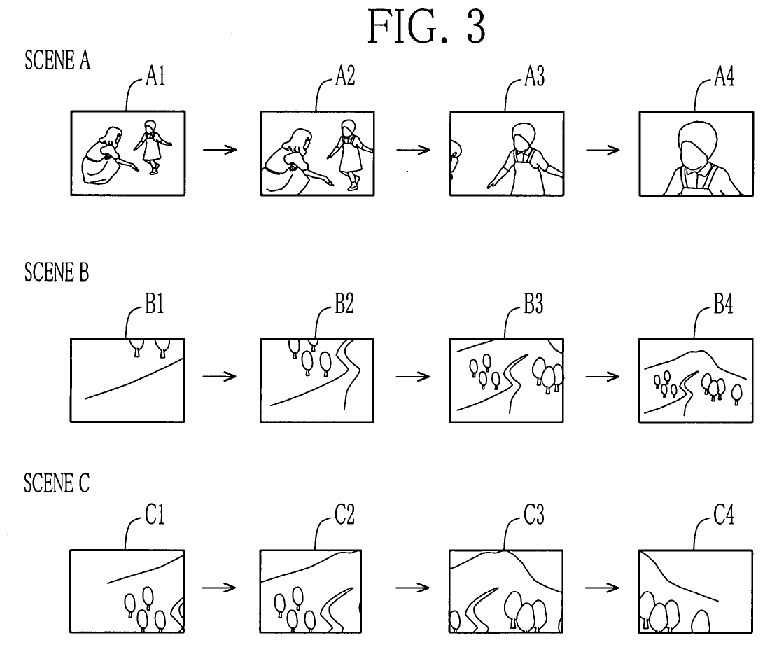

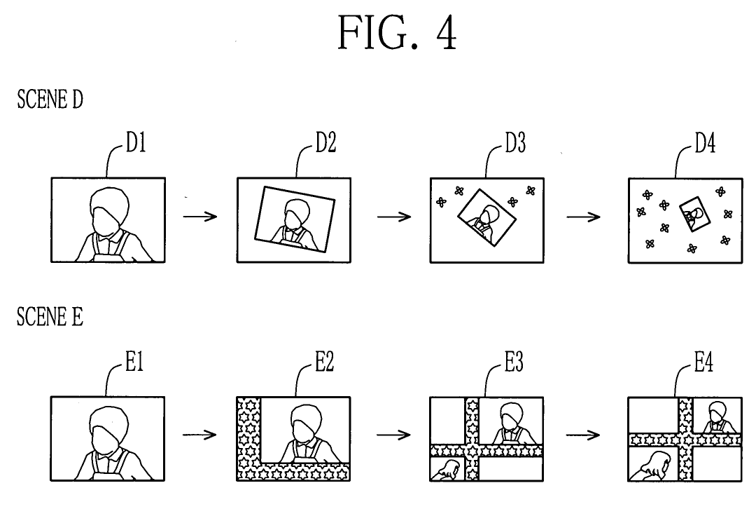

In FIGS. 3 and 4, when the photo movie being produced, the still images are modified to be given the special effects such as electronic zooming and panning. Scenes A to E are explanatory view showing examples of the special effects. The scene A begins with a frame A1, which shows a mother and a child, goes through scenes A2 and A3 which focus on and gradually zoom in on the child's face, and ends with a frame A4, which is a close-up of the child's face. Each frame A1 to A4 of the scene A is generated by electronically zooming in on a part of the original image (the still image) corresponding to the scene A1, and cropping the images of the part with different magnification from the original image.

The scene B begins with a frame B1 showing a road and ends with a frame B4 showing the road which is extended to a mountain in a distant view while gradually zooming out. As with the scene A, each frame B1 to B4 of the scene B is also generated by zooming in on a part of an original image corresponding to the frame B4, and applying electric zoom processing to the original image, and cropping partial images with different magnification from the original image. However, contrary to the scene A, which zooms in on a zoom point, the scene B zooms out from a zoom point, so the frame B1, which is the first frame of the scene B, has the highest zoom magnification, and the frame B4, which is the last frame of the scene B, has the same magnification as the original image.

The scene C begins with a frame C1 showing a left-side slope of the mountain, which is a main subject, and ends with a frame C4, which shows a right-side slope of the mountain, through the frames C2 and C3 which show the mountain in the center of the frame as if the camera pans from left to right to create a panoramic effect. Each frame C1 to C4 of the scene C is generated by cropping a part of the still image, which shows the whole mountain at the distance, while moving the viewpoint from the left to right.

The scene D begins with a frame D1, which shows the face of the child in a close-up, and the image is rotated with the size being reduced, and gradually fades out in frames D2 to D4. Then, flowers are scattered in the background of the image in frames D3 and D4. In the scene E, the size of a frame E1, which shows the child, is gradually reduced with respect to an upper right side of the screen, and the image of the mother is inserted from a lower left side of the screen while enlarging its size. Boundaries of each image are decorated with a cross-shaped belt having star patterns. The belt is inserted from a lower left side of the screen in accordance with the enlargement of the image of the mother.

The photo movie is produced by joining the above modified scenes. In the above embodiment, each scene is explained as if they were formed of four frames for the sake of convenience. However, actual frame rate of each scene is approximately 30 frames per second, for instance.

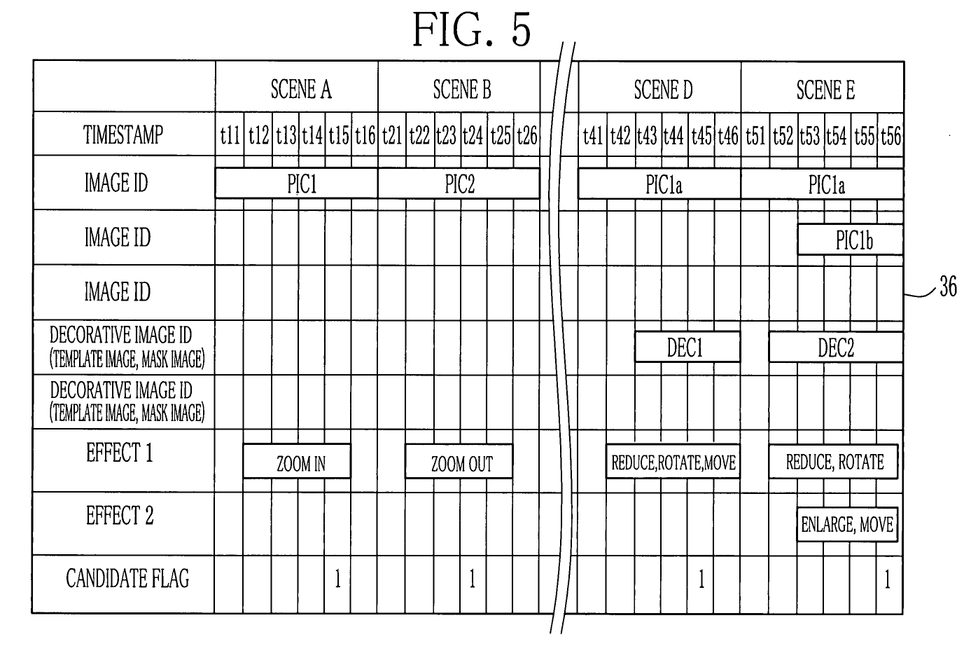

The editing conditions of the photo movie is described in the scenario file 36 as shown in FIG. 5. The scenario file 36 specifies the editing conditions of each frame in time order. The editing conditions include IDs of the images, which are used as the materials for producing the photo movie, decorative image IDs, and the types of the special effects. The lateral axis of the scenario file 36 is a time-axis and the scenario file 36 specifies the types of the special effects to be added to each image according to a timestamp of each frame.

For instance, in the scene A, an image PIC1 is used for the zooming throughout the scene. In the scene D, an image PIC1a, which is a partly cropped part of the image PIC1, is used. A special effect is added to the image PIC1a so as to rotate and move the image while reducing the size of the image. In the scene E, the image PIC1a alone is displayed in the beginning of the scene, and the image PIC1b is inserted in the middle of the scene.

The scenario file 36 can be created using various formats. An actual scenario file 36 includes detailed data such as zoom points, which are base points for zooming, the zoom magnification, position coordinates data indicating moving positions, rotation angles of the images, and inserting positions of the decorative images.

Further, in the scenario file 36, the candidate flags are recorded in association with representative frames in each scene. The specific frames, to which the candidate flags are attached, are printed in accordance with the print order from the user. The specific frames are selected from best scenes in the photo movie (zoom-up scenes and composite scenes with the decorative images, for instance). The zoom-up scenes and the composite scenes are formed only after producing the photo movie, and suitable for printing.

In the creation of the scenario file 36, the best scenes are automatically picked up and the candidate flags are recorded in association with the specific frames included in the best scenes. When the print order is placed and accepted, the frame searching section 27 reads the candidate flags in the scenario file 36 and searches the specific frames corresponding to the candidate flags.

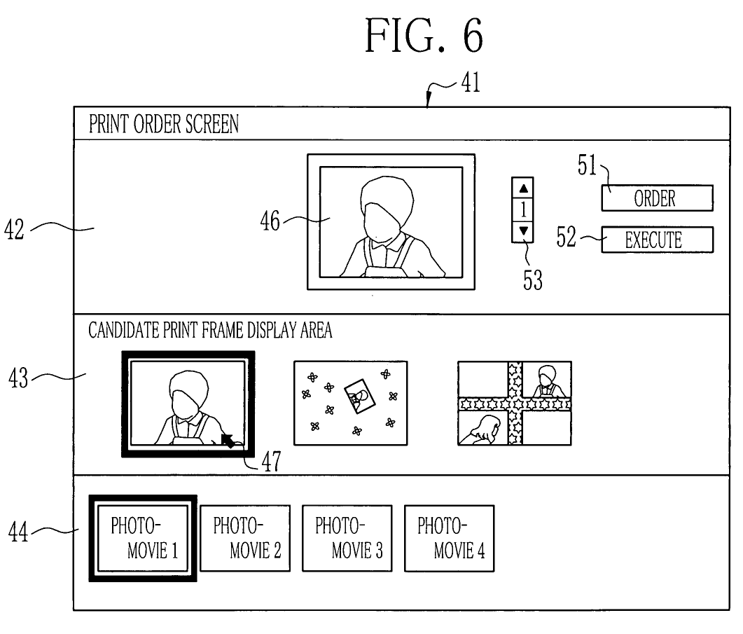

In FIG. 6, the print order screen 41 is divided into three areas, providing an operation section display area 42, a candidate print frames display area 43 and a photo movie selecting area 44 from the top. The photo movie selecting area 44 displays a list of the photo movies in the DVD medium 23. In the list, for instance, the title scenes of the respective photo movies are displayed.

When a pointer 47 of the mouse is placed on the desired photo movie in the list, the specific frames of the selected photo movie are searched according to the candidate flags in the scenario file 36, and displayed in the candidate print frame display area 43. When one of the candidate print frames is designated with the pointer 47, the frame is enlarged and displayed in an enlarged display area 46 in the operation section display area 42.

A print order button 51, an execute button 52 and a print quantity input box 53 are provided in the operation section display area 42. The print order button 51 is used for fixing the print order for the displayed frame in the enlarged display area 46. With a click of the print order button 51, the displayed print order for the listed quantity in the print quantity input box 53 is designated. The execute button 52 completes the print order of all designated frames. With a click of the execute button 52, the data of the designated frames is transferred to the HDD 18 and the printer 25.

For printing, it is possible to use the moving image data of one frame cropped from the photo movie. However, since the frame data of the moving image is inferior in image quality, the print data for the designated frame can be generated on the basis of the still image data used as the materials for the photo movie and the scenario file 36. In that case, the editing conditions are read out at the points with the candidate flags in the scenario file 36, which contains the editing conditions of each frame, and the prints of the designated frames are generated using the still image data and the decorative images. Thus, it becomes possible to provide the prints with high image quality in comparison with the frames cropped from the moving image data.

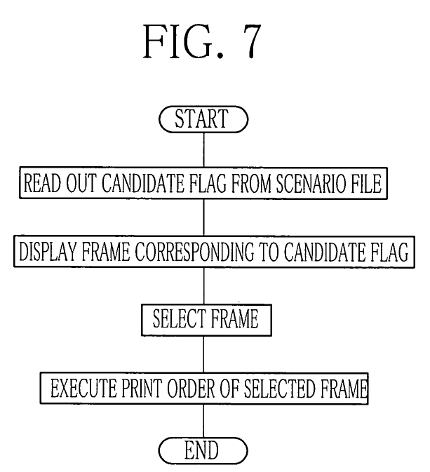

Hereinafter an operation of the above configuration is described while referring to a flowchart shown in FIG. 7. The operator sets the DVD medium 23 in the media reader 17 and runs the image editing program. When the print order is selected in the main menu, the print order screen 41 is displayed on the monitor 12.

In the photo movie selecting area 44, a list of the title scenes of all the photo movies stored in the DVD medium 23 is displayed. When one of the photo movies is selected, the candidate flags are read from the scenario file 36 of the selected movie, and thereby specific frames with the candidate flags are displayed in the candidate print frame display area 43. The print order is placed when the desired frames are selected among the displayed frames in the candidate print frame display area 43. With the candidate flags recorded in the scenario file 36, the desired scene for printing can be searched without reproducing the photo movie from the beginning. Therefore, it becomes possible to reduce the time for frame searching.

In the above embodiment, the image editing apparatus 10 automatically determines the best scenes and records the candidate flags in association with the specific frames in the best scenes at the time of producing the photo movie. However, it is also possible to select the specific frames while reproducing the photo movie immediately after the production, and record the candidate flags in association with the selected specific frames when writing out the photo movie and the scenario file 36 in the DVD medium 23.

Further, it is also possible to record the candidate flags in association with the ordered frames when the print order is executed. Thereby, it becomes easy to search the frames in reprinting.

In the above embodiment, the candidate flags are attached to the specific frames included in the best scenes. However, it is also possible to simply attach the candidate flags at predetermined intervals. Even so, the search time can be reduced in comparison with reproducing the photo movie from the beginning. It is also possible to separate the scenes at predetermined intervals, for instance, from 0 to 10 seconds, 10 to 20 seconds and so on, and select the best scene in each separation to attach the candidate flag.

In the above embodiment, when the print order is executed, the print data (the regenerated data using the still images) for the specific frames, to which the candidate flags are attached, is generated. However, it is also possible to generate the print data of the specific frames at the time of producing the photo movie, and write out the print data and the photo movie in the DVD medium 23. In this way, the specific frames can be viewed without reproducing the photo movie. In order to reduce the time for displaying the specific frames on the monitor 12, it is possible to generate thumbnail images of the print data along with the print data.

The above embodiment is the frame searching method for searching the frames to be printed in the photo movie. However, it is possible to apply the above method for other purposes than printing, for instance, for modifying and storing the specific frames.

In the above embodiment, the image editing apparatus is installed in the DPE shop or the like. However, it is also possible for individuals to install the image editing program in their PCs so as to implement the image editing apparatus. It is also possible to separate the frame searching function from the image editing apparatus and configure a frame searching apparatus.

Although the present invention has been described with respect to the preferred embodiment, the present invention is not to be limited to the above embodiment but, on the contrary, various modifications will be possible to those skilled in the art without departing from the scope of claims appended hereto.

1. An image editing apparatus comprising:
a reader for reading plural still images;
a scenario file creating section for creating a scenario file, in which editing conditions are recorded in a predetermined file format, said editing conditions being used for editing said plural images to produce a photo movie;
a photo movie producing section for producing said photo movie from said plural still images on the basis of said scenario file; and
a candidate flag writer for recording candidate flags in association with specific frames in said photo movie for indicating said frames being used for a specific purpose.

2. An image editing apparatus as claimed in claim 1, wherein said candidate flags are recorded in said scenario file when creating said scenario file or after generating said photo movie.

3. An image editing apparatus as claimed in claim 2, wherein said specific purpose is printing.

4. An image editing apparatus as claimed in claim 2, further comprising a writer for writing said plural still images, said scenario file and said photo movie in a recording medium.

5. An image editing apparatus as claimed in claim 2, further comprising a frame searching section for searching said specific frames.

6. An image editing apparatus as claimed in claim 5, further comprising a display for displaying said searched specific frames.

7. An image editing apparatus as claimed in claim 6, further comprising a print order input section for selecting and inputting print frames for print order among said specific frames displayed in said display.

8. An image editing apparatus as claimed in claim 7, wherein data for printing said print frames are generated using said still image data.

9. A frame searching apparatus of a photo movie, said photo movie being produced by editing plural still images, said photo movie and a scenario file being recorded in a recording medium, said scenario file including editing conditions of said photo movie and candidate flags, which are attached in relation to specific frames in said photo movie for indicating said frames being used for a specific purpose, said frame searching apparatus comprising:
a reader for reading out said photo movie and said scenario file from said recording medium;
a frame searching section for searching said specific frames in said photo movie according to said candidate flags.

10. A frame searching apparatus of a photo movie as claimed in claim 9, wherein said specific purpose is printing.

11. A frame searching apparatus of a photo movie as claimed in claim 9, further comprising a display for displaying said searched specific frames.

12. A frame searching apparatus of a photo movie as claimed in claim 11, further comprising a print order input section for selecting and inputting print frames for print order among said specific frames displayed in said display.

13. A frame searching apparatus of a photo movie as claimed in claim 12, further comprising a print data generating section for generating data to print said print frames from said still image data.

14. A frame searching method of a photo movie comprising the steps of:
(a) creating a scenario file for recording editing conditions for a photo movie which is produced by editing plural still images;
(b) recording candidate flags, which is associated with specific frames in said photo movie to indicate said frames being used for a specific purpose, in said scenario file;
(c) storing said scenario file and said photo movie in a recording medium, and
(d) searching said specific frames in said photo movie according to said candidate flags.

15. A frame searching method as claimed in claim 14, wherein said specific purpose is printing.

16. A frame searching method as claimed in claim 14, further comprising the step of displaying said searched specific frames in a display.

17. A frame searching method as claimed in claim 16, further comprising the step of selecting and inputting print frames for print order among said specific frames displayed in said display.

18. A frame searching method as claimed in claim 17, wherein data for printing said print frames are generated from said still image data.
